(19) United States
(12) Patent Application Publication
(10) Pub. No.: US 2016/0035184 A1
(43) Pub. Date: Feb. 4, 2016

(54) AVIATION INDUSTRY FREQUENT FLYER MILE-FFM E-CASINO & CLEARING/TRANSACTION HOUSE SYSTEM

(71) Applicant: Michael J. ERICKSON, (US)

(72) Inventor: Michael J. Erickson, Herndon, VA (US)

(73) Assignee: Michael J ERICKSON, Herndon, VA (US)

(21) Appl. No.: 14/776,183

(22) PCT Filed: Mar. 14, 2014
(86) PCT No.: PCT/US14/29405

§ 371 Date: Sep. 14, 2015

Related U.S. Application Data
(60) Provisional application No. 61/784,515, filed on Mar. 14, 2013.

(51) Int. Cl. G07F 17/32

(52) U.S. Cl. CPC G07F 17/3237; G07F 17/3286; G07F 17/3239; G07F 17/3255

(57) ABSTRACT

A computer-implemented, aviation industry sector-based gaming system that is operatively coupled to an individual user display unit and input device, includes a processor and a memory operatively coupled to the processor, that interacts with the individual user display unit and input device, such that the user inputs a plurality of selections, and a plurality of wagers, via the input device after a Transaction Clearing House recognizes the user via account information assigned to each user, and the processor is configured to perform one or more electronic games to be played by the user, and to determine the result of the one or more games when played and one or more commodities to be awarded to the user based on the result of the one or more games when played.

This PCT application claims priority to U.S. Provisional Application Ser. No. 61/784,515 filed on Mar. 14, 2013, entitled “Aviation-Based Gaming Method and System,” by Erickson, the contents of which are incorporated herein in its entirety.

### BACKGROUND OF THE INVENTION

1. Field of the Invention

The present invention relates to an electronic gaming system. Particularly, an electronic gaming system (e.g., a non-monetary gambling system) that allows users to use their frequent flyer miles (FFM) in a transaction clearing house or against other uses to possibly increase their FFM balances or conduct trading of the FFMs.

2. Description of the Related Art

Frequent flyer miles are awarded to a user based on a number of miles traveled via a specific airline, to be used for commodities, for example, including additional travel and flight upgrades. Currently there are no systems which allow a user to transfer or trade in their unused frequent flyer miles, therefore, the airline industry typically accumulates millions of unused frequent flyer miles on accounts of users. The airline carries the unused frequent flyer miles as debt and additional liability.

### SUMMARY OF THE INVENTION

An embodiment of the present invention provides a computer-implemented, aviation industry sector-based gaming system that is operatively coupled to an individual user display unit and input device. The system comprising a processor and a memory operatively coupled to the processor, that interacts with the individual user display unit and input device, such that the user inputs a plurality of selections, and a plurality of wagers, via the input device after a transaction clearing house recognizes the user via account information assigned to each user, and the processor is configured to perform one or more electronic games to be played by the user, and to determine the result of the one or more games when played and one or more commodities to be awarded to the user based on the result of the one or more games when played.

Another embodiment of the present invention provides a computer-implemented aviation-based gaming method comprising receiving a user request including commodity information associated with a user, displaying one or more electronic games available to be played via an individual user display unit; playing, via an input device of the user, one of the electronic games using the commodity information of the user request received, and providing the user with one or more commodities based on the result of the electronic game.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 is block diagram of aviation industry sector-based gaming system including a transaction clearing house that can be implemented within one or more embodiments of the present invention.

FIG. 2 is an example of onboard aircraft equipment for which the gaming system of FIG. 1 can be implemented within embodiments of the present invention.

FIG. 3 is schematic of an input screen of a user display unit and input device of the system of FIG. 1 that can be implemented within embodiments of the present invention.

FIG. 4 is a block diagram of a computing system to be implemented in accordance with embodiments of the present invention.

FIG. 5 is a flowchart illustrating a method for generating energy using the system of FIG. 1 in accordance with one or more embodiments of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Specific details are given in the following description to provide a thorough understanding of the embodiments. However, it will be understood by one of ordinary skill in the art that the embodiments may be practiced without these specific details. For example, systems, networks, processes, and other components may be shown as components in block diagram form in order not to obscure the embodiments in unnecessary detail. Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The present invention as will be described in greater detail below provides a gaming system which is software based implemented by a computer system. The system is operatively coupled to a personally-owned display unit and input device of a user. The user may play one or more electronic games (e.g., video gambling games) and interact with other the users of the system via their personally-owned devices. The users also interact with the airline systems, and travel agencies, for example, via a transaction clearing house to be awarded additional commodities or trade commodities with other users.

Embodiments of the present invention enable a travel or airline-related person (e.g., an airline frequent flyer) to gamble their accumulated frequent flyer miles in an effort to increase the FFM balances and to exchange their FFMs for variety of commodities including for example, airline for travel ticketing, airline for seat and amenities upgrades, airline for meals and beverages, airport food and beverage concessionaires, hotels and travel industry agencies for future travel and accommodations.

Further, embodiments of the present invention, allow users to transfer their FFM balances back to the transaction clearing house for distribution to other users, for example, relative of the users or other persons.

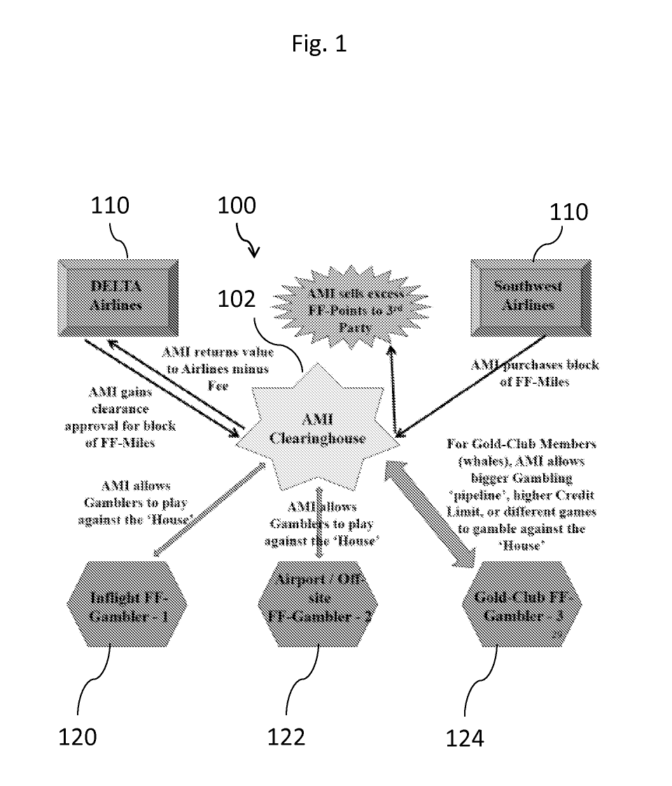

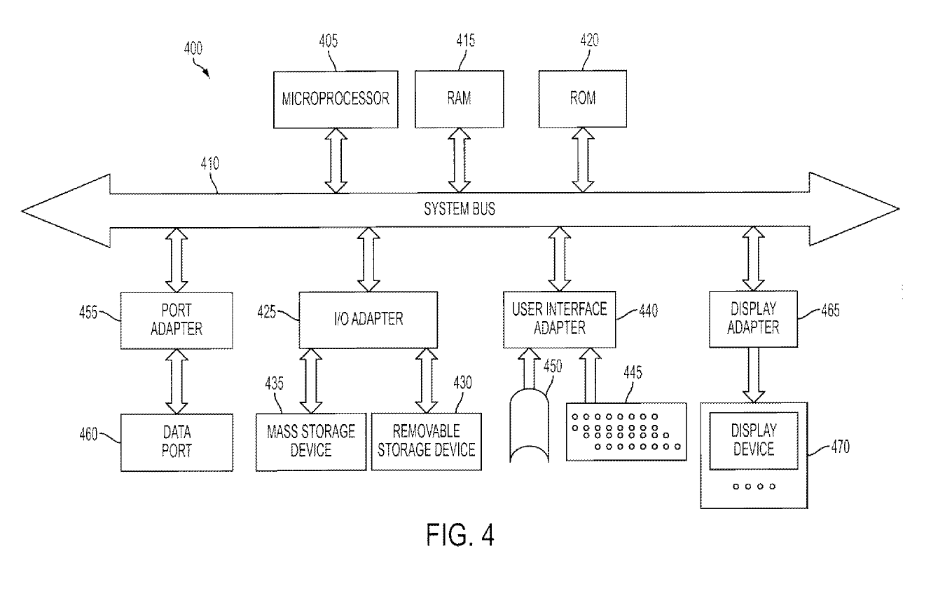

FIG. 1 is block diagram of aviation industry sector-based gaming system 100 that including a transaction clearing house 50 in accordance with one or more embodiments of the present invention. The computing system 400 of FIG. 4 may be implemented within the system 100 and the user device (e.g., a handheld electronic device) interfacing with the system 100.

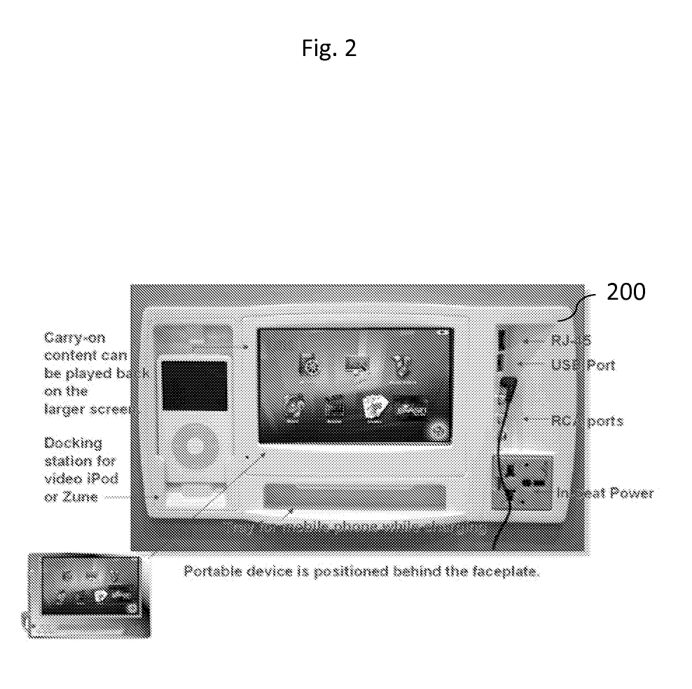

According to one or more embodiments, the system 100 may include a processor 405 and a memory 415 operatively coupled to the processor 405, that interacts with the individual user display unit (200 as depicted in FIG. 2 or 445 as depicted in FIG. 4) and input device (e.g., a keyboard 470 as depicted in FIG. 4), such that the user inputs a plurality of selections, and a plurality of wagers, via the input device after a transaction clearing house 102 recognizes the user via account information assigned to each user, and the processor 405 is configured to perform one or more electronic games to be played by the user, and to determine the result of the one or more games when played and one or more commodities to be awarded to the user based on the result of the one or more games when played. Further, as shown in FIG. 1, the transaction clearing house 102 interfaces with one or more airlines 110 and one or more FFM users 120, 122 and 124 to operate the system 100.

According to one or more embodiments, the FFM users 120, 122 and 124 may play the electronic games against the system itself or each other, anonymously.

The transaction clearing house 102 returns the value of the users FFMs minus a purchase fee charged to the airline 110 for participation. The transaction clearing house 102 therefore updates the FFM users frequent flyer miles with the respective airlines 110.

The system 100 further includes a storage device (435 as depicted in FIG. 4) configured to receive and store the commodity information and gaming information associated with one or more electronic games.

The system is configured to receive a user request including commodity information associated with that user and process the user request via the processor 405, and to display one or more electronic games available to be played via the individual user display unit (200 or 445).

According to one or more embodiments, the system is complementary and matching to the programming of the individual user display unit 200 and input device of the user such that a sequence of video images to be generated on the individual user display unit 200 after the after the transaction clearing house 102 recognizes the account information of the user, then a sequence of video images representing an electronic game selected from the group of electronic games.

According to one or more embodiments, the commodity information comprises frequent flyer miles earned by the user or by other users.

According to one or more embodiments, the system 100 being compatible with the input device having an individualized display driver and a display driver system within the transaction clearing house, such that after the sequence of video images has been displayed, an outcome of the electronic game represented by the sequence of video images is used to determine a FFM-Balance payout associated with the outcome of the electronic game.

According to the embodiments of the present invention, the electronic game is a non-monetary video gambling game.

According to one or more embodiments of the present invention, the system 100 may be implemented as a software via a standalone via a stand-alone handheld electronic device, a stand-alone Kiosk/Terminal, independent of aviation settings through an independent, user-owned device, or through an independently controlled Internet-based input system.

Alternatively, the system 100 may be implemented onboard an aircraft by the input device of the user, or through user interaction with an aircraft-in-seat, installed input device 200 as shown in FIG. 2. When implemented within an aircraft-in-seat installed input device 200, the software is integrated with the existing aircraft cabin network.

According to embodiments of the present invention, the system 100 may further comprise an electronic generator to generate different display patterns on the individual user display unit, wherein a user plays by initiating a game; and the initiation of the game causes the electronic generator to generate display patterns. The electronic generator includes a random number generator and the display patterns are provided in a random manner.

The timing of the initiation of the game determines the random numbers to be generated wherein different combinations within specific electronic games may have different probabilities and different prize entitlements.

One or more embodiments of the system 100, involve interaction with an airline-sponsored program and the users thereof. The system 100 is therefore able to conduct billing, clearing of transactions, and reconciliation services for a respective airline and users, and to perform reporting.

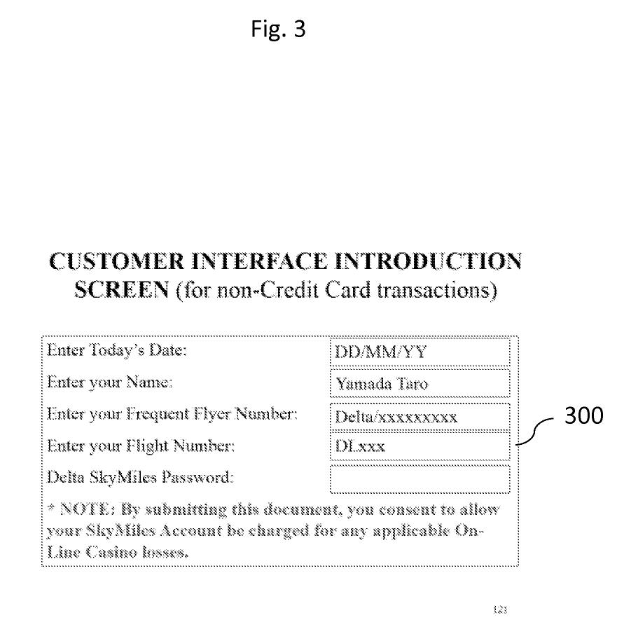

FIG. 3 is schematic of an input screen 300 of shown in the user display unit 200 or 470 and input device 445 that can be implemented within embodiments of the present invention. As shown in FIG. 3, the user is able to input their identification information including their name and commodity information including their frequent flyer number flight number and the specific airline miles password. This commodity information is used to grant access to and initiate the gaming system 100.

FIG. 4 is a block diagram of a computing system 400 that can be implemented within one or more embodiments of the system 100 and/or the user device. The computing system 400 includes at least one microprocessor or central processing unit (CPU) 405. The CPU 405 is interconnected via a system bus 410 to a random access memory (RAM) 415, a read-only memory (ROM) 420, an input/output (I/O) adapter 425 for connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

The ROM 420 contains the basic operating system for the computer system 400. The operating system may alternatively reside in the RAM 415 or elsewhere as is known in the art. Examples or removable data and/or program storage device 430 include magnetic media such as floppy drives and tape drives and optical media such as CD ROM drives. Examples of mass data and/or program storage device 435 include hard disk drives and non-volatile memory such as flash memory. In addition to the keyboard 445 and the mouse 450, other user input devices such as trackballs, writing tablets, pressure pads, microphones, light pens, and position sensing screen displays may be connected to user the user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using the keyboard 445. In view of the above, the present method embodiment may therefore take the form of a computer or controller implemented processes and apparatuses for practicing those processes. This disclosure can also be embodied in the form of computer program code containing instructions embodied in tangible media, such as floppy diskettes, CD ROMs, hard drives, or any other computer-readable storage medium, wherein, when the computer program code is loaded into and executed by a computer or controller, the computer becomes an apparatus for practicing the invention. This disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

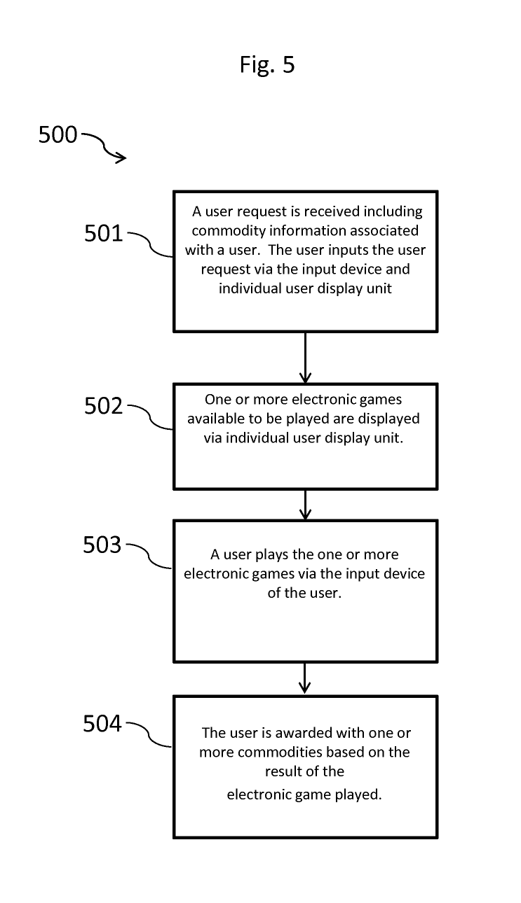

FIG. 5 is a flowchart illustrating a method 500 for generating energy using the system 100 of FIG. 1. The method 500 begins at operation 501 where a user request is received including commodity information associated with a user. The user inputs the user request via the input device and individual user display unit.

From operation 501 the process continues to operation 502 where one or more electronic games available to be played are displayed via individual user display unit.

From operation 502, the process continues to operation 503 where a user plays the one or more electronic games via the input device of the user.

From operation 503, the process continues to operation 504 where the user is awarded with one or more commodities based on the result of the electronic game played.

The system of the present invention creates a software-driven, web-based aviation frequent flyer miles purchasing and transaction clearing house system that interacts with both airline loyalty program organizations, and other FFM users to accomplish their transactions.

According to other embodiments of the present invention, the system creates a non-monetary business service that allows for negotiating and handling of the transfer of FFM balances between airline loyalty programs, travel and tourism industry entities, and FFM users through various business models.

According to other embodiments of the present invention, one or more internet websites for hosting the gaming software and uploading the gaming software for customer access may be included.

According to yet other embodiments of the present invention, a network/hubbing station may be provided to allow multi-platform customer access via various communication devices e.g., smartphones and tablets, via the Internet.

The system according to one or more embodiments, may be offered as an alternative on an entertainment menu aboard aircraft for users.

While the invention has been described in terms of its preferred embodiments, it should be understood that numerous modifications may be made thereto without departing from the spirit and scope of the present invention. It is intended that all such modifications fall within the scope of the appended claims.

What is claimed is:

1. A computer-implemented, aviation industry sector-based gaming system that is operatively coupled to an individual user display unit and input device, the system comprising:
a processor and a memory operatively coupled to the processor, that interacts with the individual user display unit and input device, such that the user inputs a plurality of selections, and a plurality of wagers, via the input device after a Transaction Clearing House recognizes the user via account information assigned to each user, and the processor is configured to perform one or more electronic games to be played by the user, and to determine the result of the one or more games when played and one or more commodities to be awarded to the user based on the result of the one or more games when played.

2. The system of claim 1, further comprising:
a storage device configured to receive and store the commodity information and gaming information associated with one or more electronic games wherein the system is configured to receive a user request including commodity information associated with that user and process the user request via the processor, and to display one or more electronic games available to be played via the individual user display unit.

3. The system of claim 2, wherein the system being complementary and matching to programming of the individual user display unit and input device of the user such that a sequence of video images to be generated on the individual user display unit after the after the Transaction Clearing House recognizes the account information of the user, then a sequence of video images representing an electronic game selected from the group of electronic games.

4. The system of claim 3, wherein the commodity information comprises Frequent Flyer Miles (FFM) earned by the users.

5. The system of claim 4, wherein the system being compatible with the input device having an individualized display driver and a display driver system within the Transaction Clearing House, such that after the sequence of video images has been displayed, an outcome of the electronic game represented by the sequence of video images is used to determine a FFM-Balance payout associated with the outcome of the electronic game.

6. The system of claim 5, wherein the electronic game is a video gambling game.

7. The system of claim 1, wherein the operation of the system is performed via a stand-alone handheld electronic device, a stand-alone Kiosk/Terminal, independent of aviation settings through an independent, user-owned device, or through an independently controlled Internet-based input system.

8. The system of claim 1, wherein the operation of the system is performed onboard an aircraft either from the input device of the user, or through user interaction with an aircraft-in-seat, installed input device.

9. The system of claim 1, wherein one or more commodities comprises Frequent Flyer Miles-FFM of other aviation industry users.

10. The system of claim 1, wherein the system further comprises:
an electronic generator to generate different display patterns on the individual user display unit, wherein a user plays by initiating a game; and the initiation of the game causes the electronic generator to generate display patterns.

11. The system of claim 10, wherein the electronic generator includes a random number generator and the display patterns are provided in a random manner.

12. The system of claim 11, wherein timing of the initiation of the game determines the random numbers to be generated wherein different combinations within specific electronic games may have different probabilities and different prize entitlements.

13. The system of claim 1, wherein the system interacts with an airline-sponsored program and the users thereof.

14. The system of claim 1, further configured to conduct billing, clearing of transactions, and reconciliation services for a respective airline and users, and for performing reporting.

15. A computer-implemented aviation-based gaming method comprising:
receiving a user request including commodity information associated with a user;
displaying one or more electronic games available to be played via an individual user display unit;
playing, via an input device of the user, one of the electronic games using the commodity information of the user request received; and
providing the user with one or more commodities based on the result of the electronic game.

16. The method of claim 15, wherein the commodity information comprises frequent flyer miles (FFM) earned by the user.

17. The method of claim 15, wherein the electronic game is a video gambling game.

18. The method of claim 15, wherein the gaming method is performed via a handheld electronic device, a stand-alone kiosk/terminal, independent of aviation settings through an independent, user-owned device, or through an independently controlled Internet-based input system.

19. The method of claim 15, wherein the gaming method is performed onboard an aircraft from the input device of the user, or through user interaction with an aircraft-in-seat, installed input device.

20. The method of claim 15, wherein the one or more commodities comprises frequent flyer miles (FFM) of other aviation industry users.
